(19) United States
(12) Patent Application Publication
(10) Pub. No.: US 2010/0146410 A1
(43) Pub. Date: Jun. 10, 2010

(54) MARKUP LANGUAGE STREAM COMPRESSION USING A DATA STACK

(76) Inventors: Barrett Kreiner, Woodstock, GA (US); Ronald Perrella, Annapolis, MD (US)

Correspondence Address: AT&T Legal Department - PK;Attn: Patent Docketing, One AT&T Way, Room 2A-207, Bedminster, NJ, 07921, US

(21) Appl. No.: 12/332,227

(22) Filed: Dec. 10, 2008

(51) Int. Cl. G06F 3/00

(52) U.S. Cl. 715/760

(57) ABSTRACT

Markup language streams are compressed during transport by using a data stack. During parsing of the stream, a push command is sent in conjunction with an encountered open tag to instruct that the encountered open tag be pushed onto a next location of the data stack of a destination device. The encountered open tag is to be used to start an expression within a copy of the markup language stream being reconstituted at the destination. Encountered textual data strings of the stream are sent for inclusion in the expression within the markup language stream being reconstituted at the destination device. A pop command is sent that instructs that the encountered open tag present in the data stack at the current location be used as an encountered close tag to close the expression within the copy of the markup language stream being reconstituted at the destination device.

### TECHNICAL FIELD

Embodiments relate to markup language streams in transit. More particularly, embodiments relate to the compression of the markup language streams being transported by using a data stack.

### BACKGROUND

Markup language documents, such as extensible markup language (XML), hypertext markup language (HTML), and the like, may be transported from one device to another over a network. The markup language documents in transit are referred to herein as markup language streams. As with any data in transit, the markup language streams pass from node to node in a network until reaching the ultimate destination.

In passing through the various nodes between the origination point and the ultimate destination, the markup language streams may take up a considerable amount of bandwidth available to the nodes. As markup language documents are considered to be a de facto standard for communicating over networks including the Internet, a large percentage of the traffic carried by network nodes may be markup language streams. Considering that markup language streams often have a significantly poor ratio of message to information, the ratio of message to information for throughput by a network node carry markup language traffic may have a similarly poor ratio as well.

### SUMMARY

Embodiments address issues such as these and others by providing for compression of markup language streams by using a data stack maintained at the destination according to commands from a source. In this manner, at least some of the tags encountered in a markup language stream may be accounted for by relatively small stack commands that get transferred between network nodes in place of transferring the typically larger tags.

Embodiments include a method of compressing a markup language stream. The method involves parsing the markup language stream at a source device. During the parsing, upon encountering each open tag at the source, the method involves sending by the source device a push command in conjunction with the encountered open tag that instructs that the encountered open tag be pushed onto a next location of a data stack at a destination device, instructs that the next location thereafter is to become a current location of the data stack, and instructs that the encountered open tag is to be used to start an expression within a copy of the markup language stream being reconstituted at the destination. During the parsing, upon encountering each textual data string of an expression corresponding to at least one of the open tags at the source, the method involves sending by the source device the textual data string for inclusion in the expression within the markup language stream being reconstituted at the destination. During the parsing, upon encountering each close tag at the source, the method further involves sending by the source device a pop command that instructs that the encountered open tag present in the data stack at the current location is to be used as a close tag to close the expression within the copy of the markup language stream being reconstituted at the destination and that the location preceding the current location thereafter is to become the current location.

Embodiments include a computer readable medium containing instructions that when implemented result in the performance of acts. The acts include parsing the markup language stream at a source device. During the parsing, upon encountering each open tag at the source, the acts further include sending by the source device a push command in conjunction with the encountered open tag that instructs that the encountered open tag is to be pushed onto a next location of a data stack of a destination device, and instructs that the next location thereafter is to become a current location of the data stack and that the encountered open tag is to be used to start an expression within a copy of the markup language stream being reconstituted at the destination. During the parsing, upon encountering each textual data string of an expression corresponding to at least one of the open tags at the source, the acts further include sending by the source device the textual data string for inclusion in the expression within the markup language stream being reconstituted at the destination. During the parsing, upon encountering each close tag at the source, the acts include sending by the source device a pop command that instructs that the encountered open tag present in the data stack at the current location is to be used as a close tag to close the expression within the copy of the markup language stream being reconstituted at the destination and that the location preceding the current location thereafter is to become the current location.

Embodiments include a source device for compressing a markup language stream. The source device includes at least one external data connection. The source device further includes a processor that parses the markup language stream as it is being received into the memory. During the parsing, upon encountering each open tag at the source, the processor sends a push command in conjunction with the encountered open tag that instructs that the encountered open tag is to be pushed onto a next location of a data stack of a destination device which thereafter is to become the current location of the data stack and that the encountered open tag be used to start an expression within a copy of the markup language stream being reconstituted at the destination device. During the parsing, upon encountering each textual data string of an expression corresponding to at least one of the open tags at the source, the processor sends the textual data string for inclusion in the expression within the markup language stream being reconstituted at the destination device. During the parsing, upon encountering each close tag at the source, the processor sends a pop command that instructs that the encountered open tag present in the data stack at the current location is to be used as a close tag to close the expression within the copy of the markup language stream being reconstituted at the destination device and that the location preceding the current location thereafter is to become the current location.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows an example of an operating environment for illustrative embodiments.

FIG. 2 shows an example of a device that operates according to illustrative embodiments.

FIG. 3 shows an example of logical operations performed by a device acting as a source of a markup language stream according to illustrative embodiments.

FIG. 4 shows an example of logical operations performed by a device acting as a destination of a markup language stream according to illustrative embodiments.

### DETAILED DESCRIPTION

Embodiments provide compression of markup language documents by using a data stack that is maintained at a destination device and may also be maintained at a source device. The source determines when a previously transmitted tag in the stack can be popped by the destination to place the tag into a location in the markup language stream being reconstituted at the destination, such as popping an open tag text from the stack to place a corresponding close tag into the markup language stream without the need to transmit the text of the close tag.

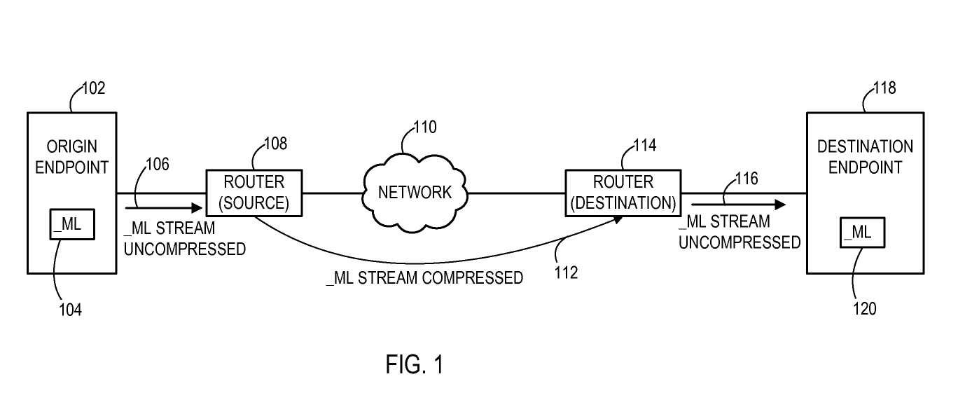

FIG. 1 shows an example of an operating environment for various illustrative embodiments that provide compression of markup language streams traveling between origination and destination endpoint devices 102, 118. In this example, the compression is being provided as a network service which may appear transparent to the applications implemented on the endpoint devices 102, 118. However, it will be appreciated that the compression may be provided at the endpoint devices 102, 118 rather than as a network service.

In this example, the origination endpoint device 102, such as a personal computer, handheld device, or a server computer, may possess a markup language document 104 from which a markup language stream is being sent. The origination endpoint device 102 may instead be generating the markup language stream on the fly. The origination endpoint device 102 may begin sending the markup language stream to the destination endpoint device 118 as an uncompressed markup language stream 106.

After one or more hops in the transport to the destination endpoint device 118, the markup language stream 106 is received at a router 108 which resides somewhere within a data network 110. The router 108 may reside at the edge of the data network 110 as shown, or may reside somewhere deeper into the network 110. In this example, the router 108 performs the compression on the uncompressed markup language stream 106 that is being received to output a compressed markup language stream 112. This router 108 is referred to as a source of the compressed markup language stream. Details of the compression performed by the router 108 of this example are discussed below.

Likewise, another router 114 that is closer to the destination endpoint device 118 receives the compressed markup language stream 112. This router 114 then decompresses the compressed markup language stream 112 to output a reconstituted markup language stream 116. The reconstituted markup language stream 116 may be used on the fly at the destination endpoint device 118 and/or may be saved as a markup language document 120.

This reconstituted markup language stream 116 matches the original markup language stream 106, to a very precise or even exact manner according to some embodiments. According to other embodiments, the reconstituted markup language stream 116 may match the original markup language stream 106 to the extent necessary to convey the same information but not be an exact match. This may be the case in examples where formatting is omitted, such as where unnecessary white space, tabs, and the like that are present in the original markup language stream 106 are omitted in the reconstituted markup language stream 116. This may also be the case where invalid tags of the original markup language stream 106 are corrected within the reconstituted markup language stream 116.

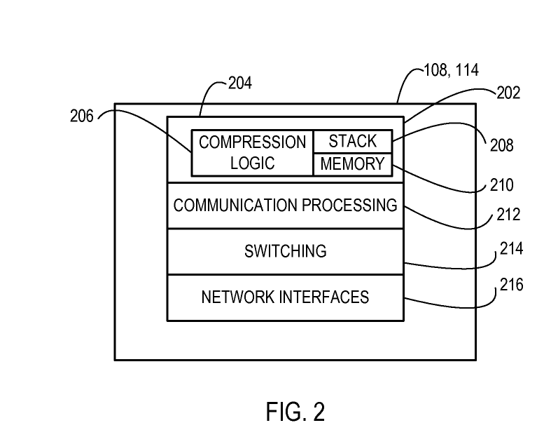

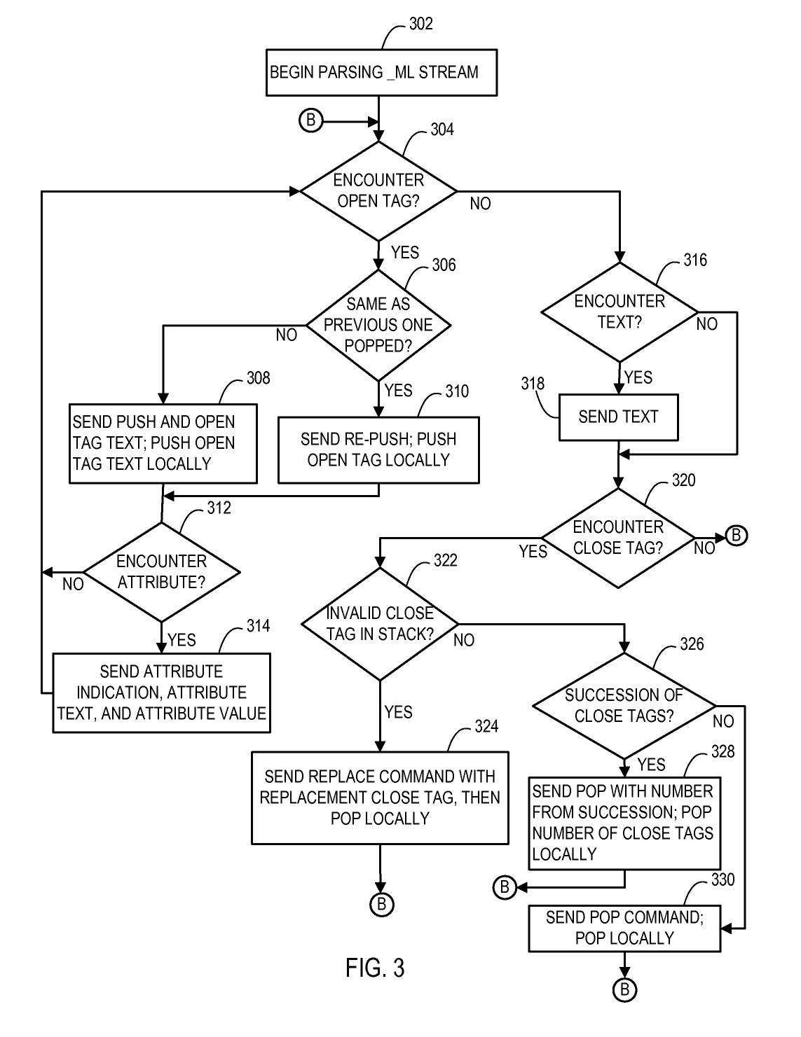

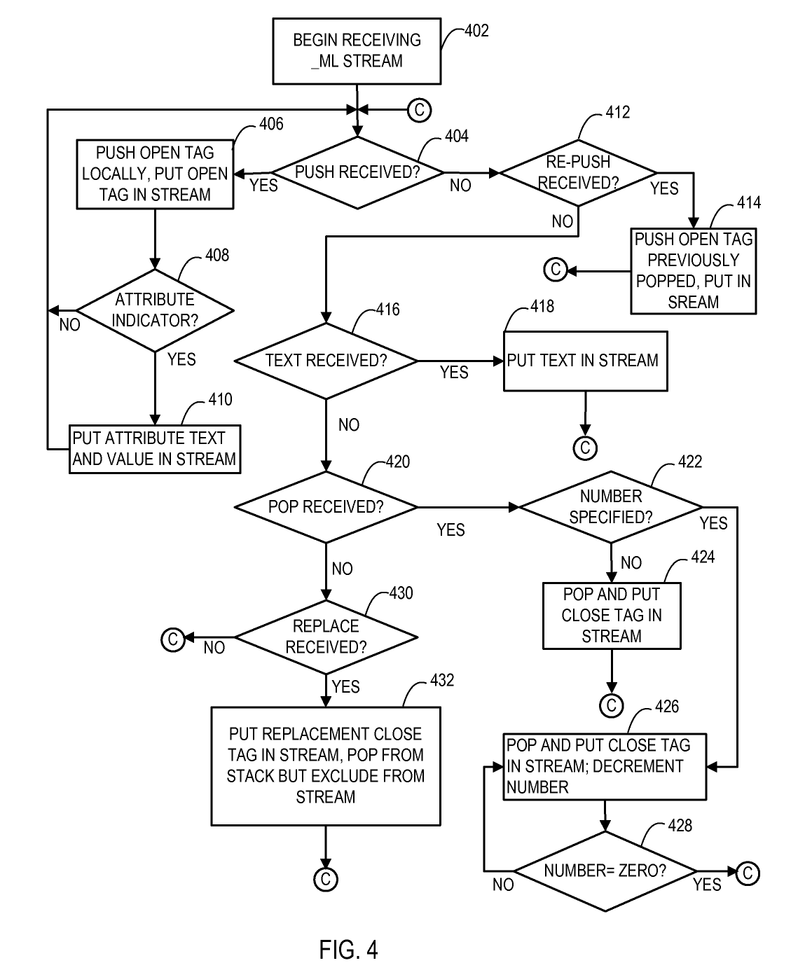

FIG. 2 shows components of one example of a router 108, 114 that may be used to compress and/or decompress a markup language stream. The router 108, 114 includes a processor 204 and a memory space 202. The processor 204 implements compression logic to perform the compression and decompression procedures such as those discussed below in relation to FIGS. 3 and 4. The processor 204 implement the compression logic as hardwired digital logic or otherwise in hardware, in firmware, or in the case of a general purpose programmable processor, as instructions accessed from the memory space 202.

The memory space 202 may be a stand alone memory device or integrated into other hardware such as within the hardware of the processor 204. The memory space 202 may include random access memory, read only memory, and/or combinations of the two. The memory space 202 may be partitioned into several working spaces, one being a data stack 208 that is devoted to the compression procedure and the other being a working memory space 210 such as where an uncompressed markup language stream may be queued and/or where a compressed markup language stream may be reconstituted.

The memory space 202 is an example of a computer readable medium which store instructions that when performed implement various logical operations. Such computer readable media may include various storage media including electronic, magnetic, and optical storage. Computer readable media may also include communications media, such as wired and wireless connections used to transfer the instructions or send and receive other data messages.

The router 108, 114 may also include a communication processing block 212 that may be a separate processor or may be an integrated function of the processor 204. The communication processing block 212 may handle the various duties of the communications protocol stack, not to be confused with the data stack 208. The communications processing block 212 may receive data in the low layers of the communications protocol stack and may make determinations such as whether to request that a data frame be re-sent at a link layer, that a packet be re-sent at a packet layer, and so forth. The communications processing block 212 may also recognize when the router 108, 114 is receiving information that needs to be passed up to an application layer which is being implemented by the processor 204 and when to pass application layer information from the processor 204 back down through the communication protocol stack. In the examples discussed herein, the application layer functions of the processor 204 include the markup language compression procedures.

The physical switching of data between physical network connections may be handled be a switching module 214 that performs the conventional sending and receiving of low layer data communications via the physical network interfaces 216, such as via Ethernet, SONET, ATM, and the like. The switching module 214 directs information received from one port of the network interfaces 216 out through an appropriate other port of the network interfaces 216 so as to properly transport packets on to a next hop in the transport path.

FIG. 3 shows a set of logical operations that may be performed by the processor 204 of the router 108 according to various embodiments when compressing a markup language stream 106. The logical operations begin by the processor 204 beginning to parse the markup language stream that has been passed up by the communications processing block 212. The processor 204 begins looking for well-known aspects of expressions found in a markup language stream such as open tags, attributes and related values of open tags, text, and close tags including successions of close tags.

At a query operation 304, the processor 204 detects whether an open tag has been encountered. An open tag has a particular format in a markup language stream. In this example, the format includes “<”, text, and “>” in that order. If an open tag is not encountered, then operational flow proceeds to a query operation 316 that is discussed below. In this particular example, if an open tag is encountered, then a query operation 306 detects whether the open tag being encountered is the same as a previous one that has been the subject of a POP. One alternative is to proceed directly from the query operation 304 to a PUSH operation 308. However, by query 306, additional compression can occur where the encountered tag is the same as a previous one that has been the subject of a POP by a RE-PUSH operation 310 where a RE-PUSH command which may be one byte or less is sent to the destination router 114 rather than sending a PUSH command plus all the characters of the open tag subject to the PUSH. The router 108 maintains its local copy of the stack 208 by also performing a PUSH for the open tag in the next stack position.

As yet another alternative not shown in FIG. 3, when the previous open tag was to be subject to a POP, the router 108 may check for the next open tag to see if it the same as the one currently subject to the POP prior to sending a POP command, and may instead send a NEXT command which may be one byte or less. The NEXT command instructs the destination router 114 to POP from the stack, which also means to put what is subject to the POP into the markup language stream being reconstituted as a closed tag, and then to PUSH that which is subject to the POP back onto the stack since it has been immediately encountered again. In this case, what could have been a POP followed by a PUSH plus the open tag characters, or what could have been a POP followed by a RE-PUSH as shown in FIG. 3, is instead just a NEXT. In this case, the router 108 maintains its local copy of the stack 208 by also performing a PUSH for the open tag in the next stack position.

Returning to the query operation 306, where the encountered open tag is not the same as the one subject to the previous POP, then operational flow proceeds to a PUSH operation 308 where the source router 108 sends a PUSH command plus the characters of the open tag, excluding the “<” and “>” characters that are automatically added by the destination router 114 when inserting the open tag being received into the markup language stream being reconstituted in response to receiving the PUSH command. The source router 108 maintains its local copy of the stack 208 by also performing a PUSH for the open tag in the next stack position.

At a query operation 312, the processor 204 detects whether the current open tag that has been encountered includes one or more attributes. If so, then the processor 204 sends an attribute indicator, the attribute text characters, and the attribute value and repeats for all attributes that are present at an attribute operation 314. Operational flow then returns to the query operation 304. Operational flow also returns to the query operation 304 where the query operation 312 detects that no attribute is present for the current open tag.

Returning to the query operation 316, where it has already been determined that an open tag is not being encountered, the query operation 316 detects whether text of an expression is being encountered. If so, then the processor 204 of the source router 108 sends the text on to the destination router 114 for inclusion in the markup language stream 116 being reconstituted at a send operation 318. It will be appreciated that one could employ additional conventional forms of textual compression when sending text, particularly where the text is a lengthy string of characters.

When text has not been encountered, then a query operation 320 detects whether a close tag is being encountered at the source router 108. If not, then operational flow returns to the query operation 304 to check for an open tag in a next data element. If a close tag is encountered, then in this example a query operation 322 detects whether the previous open tag subject to a PUSH during the preceding PUSH operation 308 will result in an invalid close tag relative to the original markup language stream. For instance, there may be a change of case in the original markup language stream, e.g., <beta> versus </BETA>, or there may be lexigraphically incorrect tag string in the original markup language stream, e.g., <alpha!!& %> versus </alpha>.

When a non-matching close tag is found in the input stream relative to the tag that has been pushed, then the processor 204 of the source router 108 sends a REPLACE command with the character text of the of the input stream close tag at a REPLACE operation 324. The source router 108 manages its local copy of the stack 208 by performing a POP, but does not alter or invalidate the value on the stack. The REPLACE command received by destination router 114 also causes that destination router 114 to POP from its local copy of the stack 208, but instead of emitting the value on the stack as a close tag into the markup language stream being reconstituted, the destination router 114 inserts the character text provided as the argument in the REPLACE command as the character text of the close tag in the reconstituted markup language stream.

In one alternative embodiment, the invalid close tag may be allowed to pass through to the reconstituted markup language stream 116 by moving from the query operation 320 directly to a query operation 326 or directly to a POP operation 330. In this embodiment, it may not be of concern that the differences between an open tag and corresponding close tag are preserved.

In another alternative embodiment, rather than using the REPLACE command to preserver the differences in the open tag and corresponding close tag, the processor 204 of the source router 108 may instead pass the close tag of the original markup language stream, e.g., </BETA>, as a text for inclusion in the markup language stream being reconstituted at the destination router 114. The processor 204 of the source router 108 may then send a REMOVE command to the destination router 114 which has the effect of a POP but causes the value popped from the stack to be excluded from the reconstituted markup language stream. Thus, the close tag of the reconstituted stream matches that of the original stream while the stack has also been properly managed.

In such an alternative or where the query operation 322 finds that there is no invalid tag, then at a query operation 326, the processor 204 of the source router 108 detects whether there is a succession of close tags, such as often appears at the end of a markup language stream but could also occur at other places. If not, then the processor 204 sends a POP command which directs the destination router 114 to POP the current open tag value from the stack 208 and use it as a close tag in the proper close tag format which in this example is “<”, “/”, text subject to the POP, and “>”. The source router 108 maintains its local copy of the stack 208 by also performing a POP for the open tag in the current stack position and the preceding stack position then becomes the current stack position (i.e., the stack pointer is then moved).

If at the query operation 326 it is detected that there is a succession of close tags, then the processor 204 of the source router 108 sends a POP command with a number that specifies the total number of close tags in succession. This indicates to the destination router 114 that the open tags subject to the POP are to be inserted into the markup language stream as close tags in the order being popped from the stack. In an alternative, rather then sending the POP plus the number, the POP could be repetitively sent the number of times but that would be a less compressed manner of putting the number close tags into the markup language stream. The source router 108 maintains its local copy of the stack 208 by also performing a POP for the number open tags starting in the current stack position, and the stack position preceding the last POP then becomes the current stack position.

These logical operations of FIG. 3 can be further illustrated by an example. Given the following fragment, which represents common markup language usage:

```
<alpha>
    <beta>
        xyz
    </beta>
    <beta>
        123
    </beta>
</alpha>
```

This example would encode as follows for an embodiment not using the RE-PUSH command, nor the POP+ number, nor the NEXT command, noting that the bracketed material indicates what is being popped but is not being sent over the network:

PUSH alpha
PUSH beta
Text xyz
POP [beta]
PUSH beta
Text 123
POP [beta]
POP [alpha]

For ease of illustration, savings from not sending the formatting characters of “<”, “>”, and “/” is not counted, and it is assumed that the commands are one byte and that the text is being sent as one byte per character. Thus, the savings of POP [beta] is three bytes on both occurrences while the savings of POP [alpha] is four bytes over an uncompressed transport.

This example would encode as follows for an embodiment that does use the RE-PUSH command, again noting that the bracketed material indicates what is being popped but is not being sent over the network:

PUSH alpha
PUSH beta
Text xyz
POP [beta]
RE-PUSH [beta]
Text 123
POP [beta]
POP [alpha]

For ease of illustration, savings from not sending the formatting characters of “<”, “>”, and “/” is not counted, and it is assumed that the commands are one byte and that the text is being sent as one byte per character. Thus, the savings of POP [beta] is three bytes at each occurrence while the savings of POP [alpha] is four bytes and the savings of RE-PUSH [beta] is three bytes over an uncompressed transport.

This example would encode as follows for an embodiment that does use the NEXT command, again noting that the bracketed material indicates what is being popped but is not being sent over the network:

PUSH alpha
PUSH beta
Text xyz
NEXT [beta]
Text 123
POP [beta]
POP [alpha]

For ease of illustration, savings from not sending the formatting characters of “<”, “>”, and “/” is not counted, and it is assumed that the commands are one byte and that the text is being sent as one byte per character. Thus, the savings of POP [beta] is three bytes while the savings of POP [alpha] is four bytes and the savings of NEXT [beta] is seven bytes over an uncompressed transport.

This example would encode as follows for an embodiment that does use the NEXT command and the POP+number, again noting that the bracketed material indicates what is being popped but is not being sent over the network:

PUSH alpha
PUSH beta
Text xyz
NEXT [beta]
Text 123
POP 2

For ease of illustration, savings from not sending the formatting characters of “<”, “>”, and “/” is not counted, and it is assumed that the commands are one byte and that the text is being sent as one byte per character. Thus, the savings of NEXT [beta] is seven bytes while the savings of POP 2 is another seven bytes over an uncompressed transport.

Other instances of FIG. 3 can be shown by the following example. Given the following fragment, which represents common markup language usage:

```
<alpha>
    <beta>
        xyz
    </BETA>
    <beta>
        123
    </beta>
</alpha>
```

This example would encode as follows for an embodiment that uses a REPLACE command to account for the change in case between the beta open tag and the BETA close tag so as to preserve the BETA close tag in the reconstituted stream. A REPLACE command can be used to also preserve any lexigraphically incorrect tag. Again, it is noted that the bracketed material indicates what is being popped but is not being sent over the network:

PUSH alpha
PUSH beta
Text xyz
REPLACE BETA
RE-PUSH
Text 123
POP [beta]
POP [alpha]

Instead of a REPLACE command, a REMOVE command not shown in FIG. 3 could be used to preserve the BETA close tag in the reconstituted stream. This example would encode as follows for an embodiment that uses the REMOVE command, again noting that the bracketed material indicates what is being popped but is not being sent over the network:

PUSH alpha
PUSH beta
Text xyz
Text </BETA>
REMOVE [beta]
PUSH beta
Text 123
POP [beta]
POP [alpha]

In addition to the stack commands discussed above in relation to FIG. 3, other commands may also be defined and used between the source router 108 and the destination router 114 when compressing the markup language stream 112 passing therebetween. For instance, whitespace outside of the markup expression may be sent along in the markup language stream 112 if desired. Commands such as WSPUSH and WSPOP could be defined to PUSH and POP a defined amount of whitespace on and off the data stack 208, such as to PUSH a TAB onto the data stack where the argument to the WSPUSH command may be TAG. In that case, a POP of a subsequent tag may include an inherent WSPOP as well as the POP of the tag on the stack. Furthermore, whitespace commands to insert whitespace into the stream may be defined, such as a WS command and a REPEAT+number command.

Referring to the original fragment above, this fragment may be encoded as:

PUSH alpha
WSPush TAB
PUSH beta
WS TAB
REPEAT 1
Text xyz
NEXT [beta] (Inherent WSPush and WSPops)
REPEAT 1
Text 123
POP [beta] (Inherent WSPop)
POP [alpha]

In this case, the original input markup language stream is being preserved through a lossless compression by preserving the whitespaces. However, a canonical form may instead be presented to the destination router 114 by the sending router 108 performing a lossy compression whereby the source router 108 discards the whitespace rather than including it in the compression.

FIG. 4 shows a set of logical operations that may be performed by a destination router 114 to act upon the information being received from the source router 108 in order to reconstitute the markup language stream 116 in an uncompressed form. The processor 204 of the destination router 114 begins parsing the received markup language compressed stream 112 at a parse operation 402. The processor 204 begins looking for stack commands, any operands for the stack commands, and the text characters.

At a query operation 404, the processor 204 detects whether a PUSH is received. If so, then the open tag of the PUSH command is pushed onto the stack 208 at the next location and the open tag of the PUSH command is inserted into the stream in the form of an open tag, including adding the formatting of “<”, text, and “>” at a PUSH operation 406. At a query operation 408, it is then detected whether an attribute indicator is subsequently sent. If so, then the attribute text and attribute value are inserted into the markup string in the attribute format, such as including “=” between the text and value of the attribute at an attribute operation 410. Operational flow then returns to the query operation 404.

If no PUSH is received, then a query operation 412 detects whether a RE-PUSH is received. If so, then the open tag that was previously popped is pushed back onto the stack at the next location and this open tag is inserted into the stream as an open tag. If no RE-PUSH command is received, then operational flow proceeds to a query operation 416. As discussed above in relation to FIG. 3, an alternative to a RE-PUSH command is a NEXT command which could be implemented here instead and would take the place of the previous POP command as well as the RE-PUSH command.

At the query operation 416, it is detected whether text is received. If so, then the text is inserted into the markup language stream 116 at a text operation 418. If not, then operational flow proceeds to a query operation 420.

At the query operation 420, it is detected whether a POP command is received. If so, then in this example, it is further detected whether a number is received as an operand of the POP command at a query operation 422. If not, then the open tag at the current location of the stack 208 is popped at a POP operation 424 and is put into the markup language stream 116 as a close tag including the proper formatting of “<”, “/”, text of the tag being popped, and “>”. The preceding location in the stack then becomes the current location (i.e., the stack pointer is moved).

If the number is specified as an operand to the POP command, then the open tag at the current location is popped and put into the markup language stream 116 as a close tag at a POP operation 426. The preceding location then becomes the current location and the number that was the operand is decremented to account for this one POP. Then, at a query operation 428, it is detected whether the number has been decremented to zero. If so, then operational flow returns to the query operation 404. If not, the POP operation 426 and the query operation 428 are repeated.

Returning to the query operation 420, if no POP has been received, then in this example a query operation 430 detects whether a REPLACE command has been received. If not, then operational flow returns to the query operation 404 to consider the next received data in the stream 112 that is being parsed. If so, then at a PUSH operation 432, the replacement close tag sent as the argument to the REPLACE command is inserted into the stream 116. The open tag at the current location is popped and is excluded from the stream 116. The preceding location in the stack then becomes the current location.

For embodiments where the REMOVE command are used rather than the REPLACE command, then the close tag is received as text at the query operation 416 and is inserted into the stream 116 at the text operation 418. Then, the query operation 430 would detect the REMOVE command and then a REMOVE operation would be performed to POP the current value from the stack but exclude it from the stream 116.

While embodiments have been particularly shown and described, it will be understood by those skilled in the art that various other changes in the form and details may be made therein without departing from the spirit and scope of the invention.

What is claimed is:

1. A method of compressing a markup language stream, comprising:
parsing the markup language stream at a source device;
during the parsing, upon encountering each open tag at the source, sending by the source device a push command in conjunction with the encountered open tag that instructs that the encountered open tag be pushed onto a next location of a data stack at a destination device, instructs that the next location thereafter is to become a current location of the data stack, and instructs that the encountered open tag is to be used to start an expression within a copy of the markup language stream being reconstituted at the destination;
during the parsing, upon encountering each textual data string of an expression corresponding to at least one of the open tags at the source, sending by the source device the textual data string for inclusion in the expression within the markup language stream being reconstituted at the destination; and
during the parsing, upon encountering each close tag at the source, sending by the source device a pop command that instructs that the encountered open tag present in the data stack at the current location is to be used as a close tag to close the expression within the copy of the markup language stream being reconstituted at the destination and that the location preceding the current location thereafter is to become the current location.

2. The method of claim 1, further comprising:
during the parsing, upon encountering an open tag that is the same as an open tag that was subject to a most recent pop, then sending by the source device a re-push command that instructs that the open tag that was most recently the subject of a pop is to be pushed onto the next location of the data stack which thereafter is to become the current location of the data stack.

3. The method of claim 1, further comprising:
during the parsing, upon encountering a close tag, detecting by the source device that there is a number of close tags in succession;
sending by the source device a pop command in conjunction with the number that instructs that the number of open tags present in the data stack starting at the current location is to be used as close tags in a successive fashion to close the expression within the copy of the markup language stream being reconstituted at the destination where the location preceding the current location by the number of locations thereafter is to become the current location.

4. The method of claim 1, further comprising:
during the parsing, upon encountering a close tag at the source device that does not match a previously encountered open tag, sending by the source device a replace command with a replacement close tag to the destination that instructs that the replacement close tag is to be inserted into the reconstituted stream while the open tag at the current location of the stack is to be excluded from being a close tag at the current location within the reconstituted stream, and that the preceding location of the data stack thereafter is to become the current location.

5. The method of claim 1, further comprising receiving the markup language stream at the source from an origination endpoint.

6. The method of claim 1, further comprising sending the markup language stream from the destination device to a destination endpoint.

7. The method of claim 1, further comprising:
upon receiving the push command in conjunction with the encountered open tag at the destination device, writing at the destination device the encountered open tag onto the next location of the data stack that thereafter is the current location and putting the encountered open tag into the copy of the markup language stream being reconstituted at the destination device;
upon receiving each textual data string of an expression at the destination device, putting the textual data string into the copy of the markup language stream being reconstituted at the destination device; and
upon receiving the pop command at the destination device, reading the open tag present in the data stack at the current location and putting the open tag into the copy of the markup language stream that is being reconstituted at the destination device as a close tag and having the location within the data stack that precedes the current location thereafter become the current location.

8. A computer readable medium containing instructions that when implemented to results in the performance of acts comprising:
parsing the markup language stream at a source device;
during the parsing, upon encountering each open tag at the source, sending by the source device a push command in conjunction with the encountered open tag that instructs that the encountered open tag is to be pushed onto a next location of a data stack of a destination device, and instructs that the next location thereafter is to become a current location of the data stack and that the encountered open tag is to be used to start an expression within a copy of the markup language stream being reconstituted at the destination;
during the parsing, upon encountering each textual data string of an expression corresponding to at least one of the open tags at the source, sending by the source device the textual data string for inclusion in the expression within the markup language stream being reconstituted at the destination; and
during the parsing, upon encountering each close tag at the source, sending by the source device a pop command that instructs that the encountered open tag present in the data stack at the current location is to be used as a close tag to close the expression within the copy of the markup language stream being reconstituted at the destination and that the location preceding the current location thereafter is to become the current location.

9. The computer readable medium of claim 8, wherein the acts further comprise:
during the parsing, upon encountering an open tag that is the same as an open tag that was subject to a most recent pop, then sending by the source device a re-push command that instructs that the open tag that was most recently the subject of a pop is to be pushed onto the next location of the data stack which thereafter is to become the current location of the data stack.

10. The computer readable medium of claim 8, wherein the acts further comprise:
during the parsing, upon encountering a close tag, detecting by the source device that there is a number of close tags in succession;
sending by the source device a pop command in conjunction with the number to the destination that instructs that the number of open tags present in the data stack starting at the current location is to be used as close tags in a successive fashion to close the expression within the copy of the markup language stream being reconstituted at the destination where the location preceding the current location by the number of locations thereafter is to become the current location.

11. The computer readable medium of claim 8, wherein the acts further comprise:
during the parsing, upon encountering a close tag at the source device that does not match a previously encountered open tag, sending by the source device a replace command with a replacement close tag that instructs that the replacement close tag is to be inserted into the reconstituted stream at the destination device while the open tag at the current location of the stack is to be excluded from being a close tag at a current location within the reconstituted stream, and that the preceding location of the data stack thereafter is to become the current location.

12. The computer readable medium of claim 8, wherein the acts further comprise receiving the markup language stream at the source device from an origination endpoint.

13. A source device for compressing a markup language stream, comprising:
at least one external data connection; and
a processor that parses the markup language stream as it is being received into the memory,
during the parsing, upon encountering each open tag at the source, the processor sends a push command in conjunction with the encountered open tag that instructs that the encountered open tag is to be pushed onto a next location of a data stack of a destination device which thereafter is to become the current location of the data stack and that the encountered open tag be used to start an expression within a copy of the markup language stream being reconstituted at the destination device,
during the parsing, upon encountering each textual data string of an expression corresponding to at least one of the open tags at the source, the processor sends the textual data string for inclusion in the expression within the markup language stream being reconstituted at the destination device, and
during the parsing, upon encountering each close tag at the source, the processor sends a pop command that instructs that the encountered open tag present in the data stack at the current location is to be used as a close tag to close the expression within the copy of the markup language stream being reconstituted at the destination device and that the location preceding the current location thereafter is to become the current location.

14. The source device of claim 13, wherein during the parsing, upon encountering an open tag that is the same as an open tag that was subject to a most recent pop, then the processor sends a re-push command that instructs that the open tag that was most recently the subject of a pop is to be pushed onto the next location of the data stack which thereafter is to become the current location of the data stack.

15. The source device of claim 13, wherein during the parsing, upon encountering a
close tag, the processor detects that there is a number of close tags in succession,
the processor sends a pop command in conjunction with the number that instructs that the number of open tags present in the data stack starting at the current location is to be used as close tags in a successive fashion to close the expression within the copy of the markup language stream being reconstituted at the destination device where the location preceding the current location by the number of locations thereafter is to become the current location.

16. The source device of claim 13, wherein during the parsing, upon encountering a close tag at the source that does not match a previously encountered open tag, the processor sends a replace command with a replacement close tag that instructs that the replacement close tag is to be inserted into the reconstituted stream while the open tag at the current location of the stack is to be excluded from being a close tag at the current location within the reconstituted stream, and that the preceding location of the data stack thereafter is to become the current location.

17. The source device of claim 13, wherein the processor receives the markup language stream from an origination endpoint.

18. The source device of claim 13, wherein the processor receives the markup language stream over a network connected to the at least one external data connection.

19. The source device of claim 13, wherein the processor sends push commands, text, and pop commands over a network connected to the at least one external data connection.

20. The source device of claim 19, further comprising a data stack and wherein the processor maintains the data stack as a copy of the data stack of the destination device.
